(19) United States
(12) Patent Application Publication
(10) Pub. No.: US 2017/0163907 A1
(43) Pub. Date: Jun. 8, 2017

(54) METHOD AND SYSTEM FOR CREATING A VIDEO ADVERTISEMENT WITH EMBEDDED USER CONTENT

(71) Applicant: ADDDON PTY LTD, Narrabeen NSW (AU)

(72) Inventors: Jonathon Charles CONNOLLY, Narrabeen NSW (AU); Justin Peterjohn CONNOLLY, Narrabeen NSW (AU)

(73) Assignee: ADDDON PTY LTD, Narrabeen NSW (AU)

(21) Appl. No.: 15/327,620

(22) PCT Filed: Jul. 21, 2015
(86) PCT No.: PCT/AU2015/050411

§ 371 Date: Jan. 19, 2017

(30) Foreign Application Priority Data
Jul. 22, 2014 (AU) 2014902832
Nov. 28, 2014 (AU) 2014904834

(51) Int. Cl. H04N 5/272; G06Q 30/00; H04N 5/262; H04N 21/234; H04N 5/222; H04N 21/81; H04N 21/4402

(52) U.S. Cl. CPC H04N 5/2723; H04N 21/812; G06Q 30/00; H04N 21/4402; H04N 21/23424; H04N 5/2224; H04N 5/2228; H04N 5/262

(57) ABSTRACT

Disclosed herein are a method and system for producing a video advertisement. The method includes the steps of receiving raw video content, applying a set of filters to said raw video content to produce a base video commercial in a first format, and displaying said base video commercial to a user. The method processes user video content received from said user to accord with said first format, such as by applying a set of filters, and merges the processed user video content with the base video commercial to produce the video advertisement.

### RELATED APPLICATION

This application is a national phase entry under 35 U.S.C. §371 of International Application No. PCT/AU2015/050411, filed Jul. 21, 2015, which claims the benefit of Australian Application No. 2014904834, filed Nov. 28, 2014 and Australian Application No. 2014902832, filed Jul. 22, 2014. The entire contents of each of the foregoing patent applications are hereby incorporated by reference.

### TECHNICAL FIELD

The present disclosure relates to an advertising method and system and, in particular, to a method and system for customising advertisements to include consumer content.

### BACKGROUND

Advertising is the practice of promoting a product in a public medium, typically with the purpose of inducing people to buy or use the relevant product. The product may be a particular good or service, a range of goods or services, or a brand that supplies goods or services. In some circumstances, the product is the brand or company as a whole and advertising can be used to promote that brand in order to connote a sense of value, quality, luxury, or style with which the brand wants to be associated.

Many different media can be used to carry advertising content, including: traditional print media, such as newspapers, magazines, billboards, and pamphlets; radio; television; and online advertising, including web banner advertisements, emails, pop-ups, floating advertisements, and frames.

Advertising content can be presented as static content, such as used in print media, or dynamic content, such as audio or video advertisements used on radio and television broadcasts or associated with multimedia advertisements used in online advertising.

In a typical advertising campaign, a company produces an advertisement extolling the features of a product that is to be promoted. In order to connect with potential consumers, the advertisement is constructed to evoke an emotional response from a viewing audience. Companies often use the services of paid celebrities or sponsored athletes in advertisements, to endorse the product and in an attempt to create a stronger connection with consumers.

Successful advertising campaigns establish a connection between the product being advertised and the consumer. The connection may be based, for example, on a theme, image, song, jingle, or video that manages to evoke the correct emotional response from the viewing audience. If an advertisement fails to evoke the correct emotional response, then sales of the brand or product being advertised will not meet expectations.

Existing advertisements are constructed by companies, often with the assistance of an advertising or marketing agency, and then presented to a viewing audience. The viewing audience may be targeted, such as through choice of medium, location of billboards, selection of broadcast network, and timing of radio or television advertisements. However, members of the viewing audience are passive recipients of the advertising content.

A need exists for an improved advertising method and system that engages a viewing audience.

### SUMMARY

The present disclosure relates to an advertising method and system.

In a first aspect, the present disclosure provides a method for producing a video advertisement, comprising the steps of:

receiving raw video content comprising a first image sequence;

applying a set of filters to said raw video content to produce a base video commercial in a first format;

displaying said base video commercial to a user;

receiving user video content from said user, said user video content comprising a second image sequence;

applying said set of filters to said user video content to generate processed user video content; and

merging said second image sequence of said processed user video content with said first image sequence of said base video commercial to produce said video advertisement.

In a second aspect, the present disclosure provides a video advertisement production system, comprising:

a server including:
a memory for storing data, a computer program, and a plurality of filters;
a processor coupled to said memory for executing said computer program stored in said memory;
a video production application forming part of said computer program, said video production application including instructions for performing the method steps of:
   receiving raw video content comprising a first image sequence;
   applying a set of filters selected from said plurality of filters to said raw video content to produce a base video commercial in a first format;
   publishing said base video commercial;
   receiving user video content;
   applying said plurality of filters to said user video content to generate processed user video content; and
   merging said second image sequence of said processed user video content with said first image sequence of said base video commercial to produce a user endorsed video advertisement.

In a third aspect, the present disclosure provides a method for producing a video advertisement, comprising the steps of:
receiving a base video commercial comprising a first image sequence, said base video commercial being associated with a profile;
displaying said base video commercial to a user;
receiving user video content from said user, said user video content comprising a second image sequence;
processing said user video content based on said profile to generate processed user video content; and
merging said second image sequence of said processed user video content with said first image sequence of said base video commercial to produce said video advertisement.

In a fourth aspect, the present disclosure provides a method for producing a video advertisement, comprising the steps of:
receiving a base video commercial comprising a first image sequence, said base video commercial being associated with a set of parameters defining a look of said base video commercial;
recording user video content in accordance with said set of parameters, said user video content comprising a second image sequence; and
merging said second image sequence of said processed user video content with said first image sequence of said base video commercial to produce said video advertisement, said video advertisement having the same look as said base video commercial.

According to another aspect, the present disclosure provides an apparatus for implementing any one of the aforementioned methods.

According to another aspect, the present disclosure provides a computer program product including a computer readable medium having recorded thereon a computer program for implementing any one of the methods described above.

Other aspects of the present disclosure are also provided.

### BRIEF DESCRIPTION OF THE DRAWINGS

One or more embodiments of the present disclosure will now be described by way of specific example(s) with reference to the accompanying drawings, in which:

FIG. 1 is a flow diagram illustrating a method of producing an video advertisement in accordance with the present disclosure;

FIG. 2 is a schematic representation of a system on which one or more embodiments of the present disclosure may be practised;

FIG. 3 is a schematic block diagram representation of a system that includes a general purpose computer on which one or more embodiments of the present disclosure may be practised;

FIG. 4 is a schematic block diagram representation of a system that includes a general smartphone on which one or more embodiments of the present disclosure may be practised;

FIG. 5 is a sample interface displayed on a display of a user computing device;

FIG. 6 is a general system architecture of a system for implementing the method of the present disclosure;

FIGS. 7a to 7e are schematic block diagrams illustrating the merging of a base commercial with user video content;

FIG. 8 is a flow diagram illustrating a method of producing an video advertisement in accordance with the present disclosure;

FIG. 9 is a flow diagram illustrating user interaction with a system in accordance with the present disclosure; and

FIG. 10 is a flow diagram illustrating advertiser interaction with a system in accordance with the present disclosure.

### DETAILED DESCRIPTION

Method steps or features in the accompanying drawings that have the same reference numerals are to be considered to have the same function(s) or operation(s), unless the contrary intention is expressed or implied.

The present disclosure provides a method and system for producing a video advertisement that merges a base video commercial with user video content. The method associates the base video commercial with a profile, wherein the profile includes a set of filters that have been applied to the base video commercial. The method applies the same set of filters to the user video content, so that the video advertisement incorporating the user video content has a consistent look and feel.

A video is a sequence of images or frames. Thus, each frame is an image in an image sequence. A scene is the information contained in a frame and may include, for example, foreground objects, background objects, or a combination thereof. A video may be encoded and compressed. Such encoding and compression may be performed intra frame, such as motion-JPEG (M JPEG), or inter-frame, such as specified in the H.264 standard. A video may include 2 dimensional (2-D) or 3 dimensional (3-D) content. A video may include recorded content, such as that captured using a video camera, or computer-generated content, or a combination thereof. Further, a video may relate to a real world environment or an artificial environment. In one arrangement, the video is used in the context of virtual reality, whereby the video is a simulation of a real environment, such as for education or training purposes, or an imagined environment, such as for gaming and the like. The method and system of the present disclosure merge a first image sequence corresponding to a base video commercial with a second image sequence derived from video content recorded by a user.

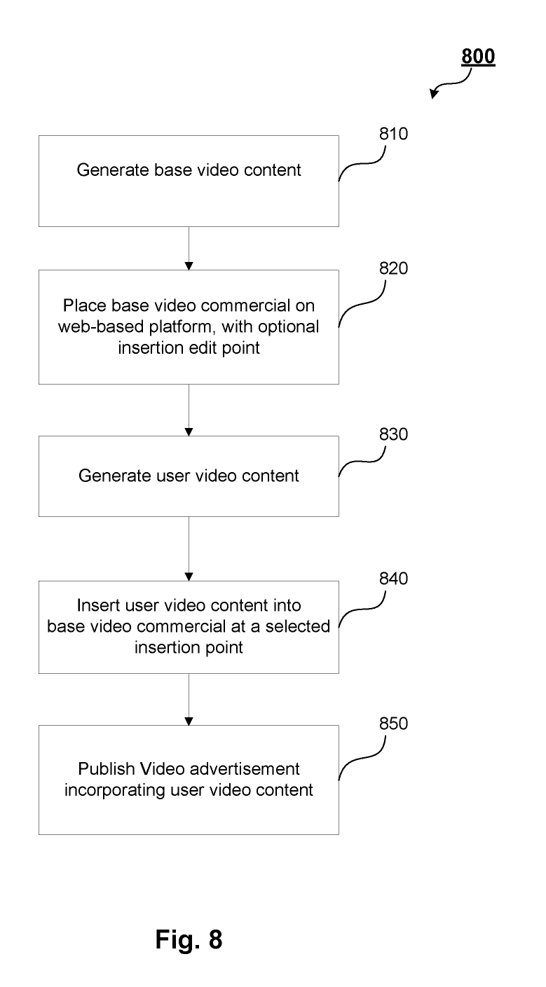

FIG. 8 is a flow diagram illustrating an overview of a method 800 for producing a video advertisement in accordance with the present disclosure. The method 800 begins at an initial step 810, in which an advertiser produces base video content. In one example, the base video content is created using traditional television commercial (TVC) production and finishing techniques.

In a second step 820, a base video commercial derived from the base video content is uploaded to a web-based platform. Depending on the implementation, the web-based platform is able to be accessed, viewed and interacted with via a web browser or software application (“app”) executing on a computing device coupled to a communications network, such as the Internet. The base video commercial is associated with a profile that includes a set of parameters defining the look and/or feel of the base video commercial. The set of parameters may include, for example, a colour look up table (LUT), as known in the art. Such LUTs are used to transform source video content to a desired output format. The base video commercial is optionally associated with one or more insertion points that define particular points of the commercial at which user generated content can be inserted.

In one arrangement, the base video commercial substantially corresponds to the base video content and processing is performed on the base video content to determine the set of parameters associated with the base video commercial. For example, base video content created with a sepia tone has an associated profile with a set of parameters that includes a LUT corresponding to colour and/or intensity values that can be used to convert a standard colour image into the sepia-toned image corresponding to the base video content.

In an alternative arrangement, one or more effects or filters are applied to the base video content in order to produce the base video commercial. In such a case, the set of parameters in the profile associated with the base video commercial corresponds to the one or more applied effects. In a further arrangement, the set of parameters is based on analysis performed on the base video content and any effects or filters applied to the base video content to produce the base video commercial.

In step 830, a user generates user video content. In one arrangement, the user uses a software application executing on a computing device to control a camera to record the user video content. The software application applies a set of parameters to the user video content, wherein the set of parameters corresponds to the set of parameters associated with the base video commercial. This ensures that the user video content has the same look and feel as the base video commercial into which the user video content is to be inserted. In another arrangement, the user provides video content that is presented to the software application, whereupon the software application applies to the video content the set of parameters associated with the base video commercial. For example, the provided video content may have been recorded on a camera or generated on a computer using a graphics program. This allows a user to provide video content from any external source and have that video content transformed into user video content with the same look and feel as the base video commercial.

Step 840 inserts the user video content into the base video commercial. Depending on the implementation, the user video content is inserted at a selected insertion point defined by the advertiser. In another arrangement, the user selects an insertion point from a set of possible insertion points defined by the advertiser. In another arrangement, the user is able to select any point in the base video commercial as an insertion point. For example, the user may simply add the user video content to the beginning or end of the base video commercial or at any selected point in the base video commercial. A software application executing on a computing device accessed by the user or on a server hosting the web-based platform merges the user video content with the base video commercial to produce a finished video advertisement.

In step 850, the co-created video advertisement featuring content from the advertiser and from at least one user is available for publication. In one arrangement, the co-created video advertisement is available for review by the user, advertiser, or other authorised entity before being published. In another arrangement, the co-created video advertisement is published on the web-based platform and is available for viewing to the general public, a set of audience members authorised by the advertiser, a set of audience members authorised by the user, or any combination thereof.

In one arrangement, the user is able to share the video advertisement via email, Short Message Service (SMS) text message, Multimedia Message Service (MMS) text message, hyperlinks, or social media platforms, such as Facebook, Twitter, Instagram, Pinterest, and the like. In such an arrangement, the video content being shared becomes the base video commercial for a receiving user. The shared video content may be the original base video commercial or the co-created video commercial featuring the base video commercial and the addition of user video content provided by the sharing user. The receiving user is then able to add new user video content to produce a new co-created finished video advertisement. Thus, multiple users are able to add respective user video content to produce different iterations of a finished video commercial that includes user video content from one or more users. Different iterations of the finished video commercial may be shared among different users, allowing an individual user to contribute to different iterations, or “conversations”, of the video commercial as that commercial is shared and distributed among different social media connections, with different users adding content along the way. In one arrangement, the base video commercial includes metadata defining the number of insertion points that limits the number of user videos that can be included in a single conversation. In another arrangement, there are no limitations on the number of user videos that can be added to the original base video commercial.

In one example, the base video commercial relates to a virtual reality environment and a user provides user video content that relates to that virtual reality environment. Such video content may be generated, for example, using a computer graphics animation program, or the like. In such an example, the base video content optionally includes metadata that provides information relating to the look and feel of the virtual reality environment in the base video commercial so that a user is able to replicate the look and feel of that virtual reality environment when creating the user video content.

It can be seen from FIG. 8 that the method of the present disclosure enables a user to produce content that is able to be integrated into an existing video commercial with the same look and feel as the video commercial. The user is then able to engage friends, family, and other social media followers by sharing the video commercial that includes the user video content. The friends, family, and other social media followers can then be entertained by the video commercial and optionally insert their own user video content into the video commercial.

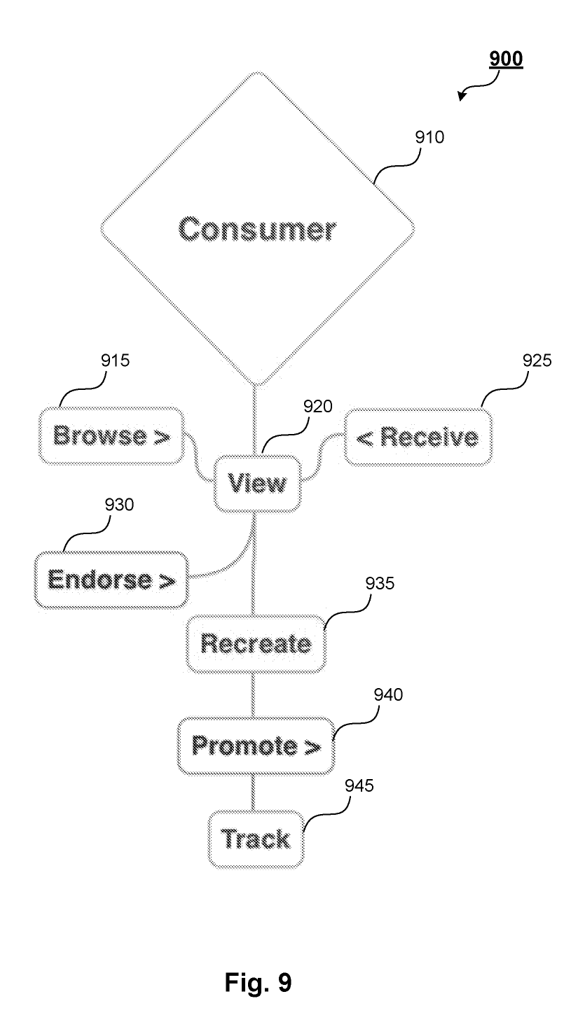

FIG. 9 is a flow diagram 900 illustrating user interaction with a system in accordance with the present disclosure. A user, in the form of a consumer 910, interacts with a web-based platform that hosts one or more video commercials produced by advertisers. In state 920, the consumer 910 is able to view the video commercials hosted by the web-based platform, either via a web browser executing on a computing device accessed by the consumer 910 or via an app executing on a computing device accessed by the consumer 910. The consumer 910 is able to browse 915 the video commercials, which may be arranged or sortable based on one or more criteria. The consumer 910 is also able to receive 925 video commercials shared by other consumers.

When the consumer 910 views 920 a video commercial, the consumer 910 is able to endorse 930 a viewed video commercial and optionally share the video commercial with other consumers, such as by sending an email, SMS, MMS, hyperlink, Tweet, or other social media interaction. The consumer 910 is also able to create 935 user video content for insertion into a viewed video commercial. The created user video content may correspond to a recreation by the consumer 910 of one or more scenes from the viewed video commercial.

The consumer 910 may also promote 940 the video commercial or a new video commercial incorporating user video content created by the consumer 910. Further, the consumer 910 may track one or more attributes associated with a video commercial, such as to whom the video commercial has been shared, which other consumers have contributed user video content to be merged into a video commercial, and the like.

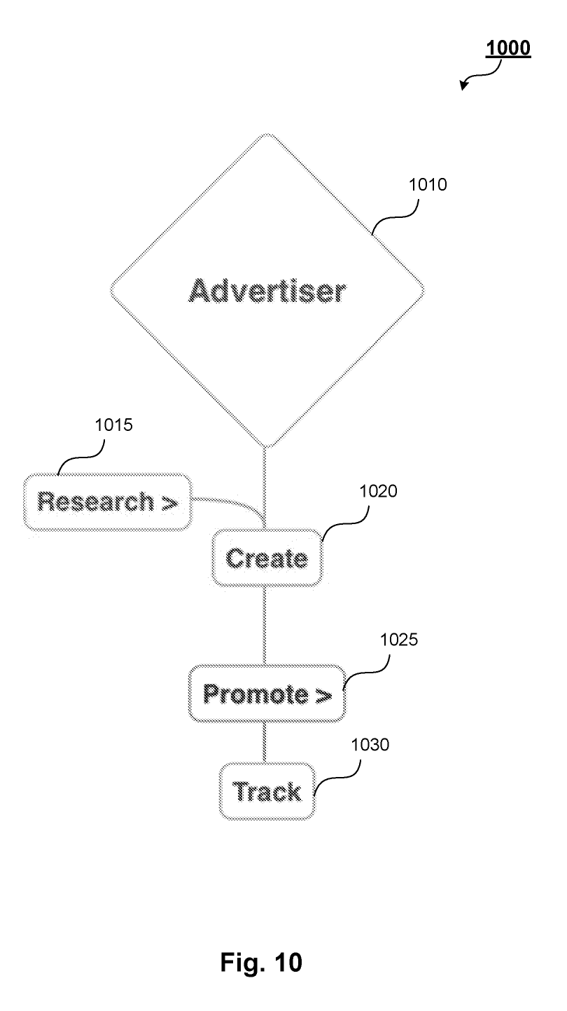

FIG. 10 is a flow diagram illustrating advertiser interaction with a system in accordance with the present disclosure. An advertiser 1010 accesses a web-based platform hosting a system for producing a video advertisement. The advertiser 1010 is able in state 1020 to create base video content, which may be influenced by marketing and research input 1015. Having created a base video commercial derived from the base video content, by applying a set of effects or filters or determining a set of effects or filters associated with the base video content, the advertiser 1010 is able to promote 1025 the base video commercial for viewing by consumers, with the goal of attracting consumers to engage with the base video commercial by creating user video content to be merged with the base video commercial.

For example, the advertiser 1010 can promote a new base video commercial to encourage consumers to provide user generated content. Such promotion may be linked, for example, to a competition that awards prizes to consumers that provide the best video commercial incorporating user video content. In one arrangement, the advertiser is able to send push notifications via an app associated with the web-based hosting system. Thus, a consumer receives a notification of a new base video commercial with which the consumer can interact.

Further, the advertiser 1030 is also able to track 1030 how many consumers have viewed the base video commercial and created new video commercials incorporating user video content.

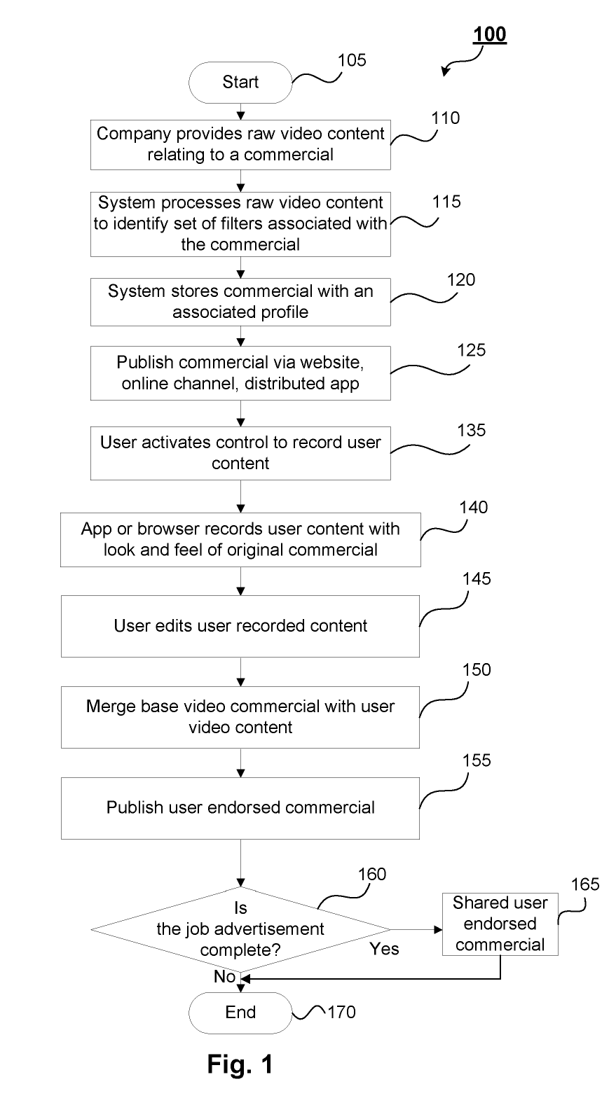

FIG. 1 is a flow diagram illustrating a method 100 for producing a video advertisement in accordance with the present disclosure. The method 100 begins at a Start step 105 and proceeds to step 110, which receives video content associated with a commercial that is to be published.

The received video content may be referred to as base video content, in that the video content is provided as the base platform for the commercial that is to be published. The base video content may also be referred to as raw video content, in the sense that the received video content is not yet associated with a profile that identifies a set of filters associated with the commercial that is to be published. The base video content, or raw video content, may include, for example, but is not limited to: raw footage recorded by a video or film camera; video content recorded by digital sources, including digital video cameras and the like; and digitally rendered content, such as animation and other forms of computer-generated imagery (CGI). Depending on the implementation, one or more filters may have been applied to the base video content (raw video content). One or more filters may also be applied to the base video content during processing of the base video content to produce a published commercial.

In step 115, the method processes the received video content and identifies a set of filters associated with the received video content.

In one arrangement, the method processes a received base video commercial to determine the set of filters. In one implementation, the received base video commercial is created in accordance with a predefined theme, wherein each theme is associated with a set of filters. In such an implementation, information associated with the received base video commercial, such as metadata, indicates the theme or set of filters used to create the base video commercial. The method is able to use that information to readily determine the set of filters. In an alternative arrangement, the method receives raw video content and applies the set of filters to produce the base video commercial. In one implementation, a plurality of sets of filters are predefined, each set of filters corresponding to a predefined theme. In a yet further arrangement, the method analyses received raw video content to identify a set of one or more filters that have been applied to the raw video content to produce a “look and feel” associated with that video content.

Step 120 stores the base video content with an associated profile, wherein the profile includes the set of filters determined in step 115. Control passes to step 125, which publishes the base video content. In one arrangement, the base video commercial is published on a website associated with the company that provided the video content in step 110. The website may be hosted, for example, on a centrally located server coupled to a communications network, wherein the centrally located server may be implemented as a discrete computing device or an array of two or more distributed computing devices.

In an alternative arrangement, the base video commercial is published within a software application (“app”) associated with the company that provided the video content. Such an app may be made available for downloading from a company website or online portal, wherein the user selects the app and the app is then pushed to a computing device accessed by the user and stored on that computing device for execution on one or more processors of that computing device. In such an arrangement, the company website or online portal is optionally able to push content to the app on the computing device of the user. Thus, the company website or online portal can push newly created content, such as new advertisements or advertisements that include new user content, to user computing devices. Further, the user can use the app to browse content on the company website or online portal and select content to download to the user computing device. In an alternative arrangement, the base video commercial is published to an internet page as online advertising.

In step 135, a viewing user activates a control associated with the base video commercial. In one arrangement, the control is a button displayed on a display screen being viewed by the user. In another arrangement, the user touches a portion of a touch screen display screen on which the base video commercial is being displayed, wherein touching the display results in a menu of options being displayed to the viewing user.

In one arrangement, the viewing user watches the commercial in step 125 via an app executing on a computing device accessed by the user. Activating the control in step 135 causes the app to activate a camera of the computing device. In one implementation, the app uses the set of filters stored in the profile associated with the commercial to process images recorded by the camera, such that a scene recorded by the user has the same look and feel as the commercial as the scene is being recorded. In another implementation, the app applies the set of filters to a recorded scene in order to obtain the same look and feel as the commercial.

In another arrangement, the viewing user watches the commercial in step 125 via a browser window displayed on a computing device accessed by the user, wherein content to be displayed in the browser window is downloaded to the computing device from a remote server. Activating the control in step 135 causes the remote server to control a camera on the computing device and apply the set of filters stored in the profile associated with the commercial to process images recorded by the camera, such that a scene recorded by the user has the same look and feel as the commercial as the scene is being recorded.

Control passes to step 140, which records content using the camera on the computing device accessed by the viewing user. This enables the user to create content of himself or herself commenting on, adding a message, or endorsing the relevant product. Further, the user can record himself or herself in a manner that mimics or reflects actions of personalities that appear in the original base video content. For example, if the base video content includes imagery of a famous footballer scoring a goal then the user can record similar content of the viewer scoring a goal. Further, the user can record content that includes the user addressing a friend or family member, so that the user can share a personalised message within the advertisement.

In an alternative arrangement, steps 135 and 140 are replaced by a single step (not shown) in which a user provides a pre-recorded or pre-generated video clip to be inserted into the commercial. In such an arrangement, activating a control associated with the base video commercial results in an app or browser through which the user is viewing the base video commercial to display a menu of options on a viewing display of the computing device accessed by the user. The menu enables the user to select one or more pre-recorded video clips from a storage device, such as a hard disk drive.

Control then passes from step 140 to optional step 145, which provides an interface to the user to allow the user to edit the recorded content to produce user video content to be merged with the base video content. As noted above, the recorded content may be either new video content recorded by the user, as described in relation to steps 135 and 140, or pre-recorded video content. In one arrangement the interface enables the user to select a start point and stop point of the recorded content. Such start and stop points may be defined, for example, using IN and OUT point handles that enable the user to select a start frame and an end frame in the recorded content.

In one arrangement, the commercial is associated with a predefined clip length, which defines the length for each video clip provided by a user. Having a defined clip length ensures that each video clip provided by a user is of the same length, which adds consistency to the final commercial. In such an arrangement, the user is able to use the interface to select a start frame and an end frame that result in a video clip of the stipulated clip length. In one implementation, the interface enables a user to select one or more sets of frames from the video content to produce video content corresponding to the clip length. In another arrangement, there is no predefined clip length and the video content provided by the user is not restricted in length.

The interface may also include, for example, a selection of songs that may be overlaid on the recorded content. In one arrangement, the interface enables the user to select pre-recorded audio content to be uploaded and overlaid on the recorded content. In one arrangement, the user video content is to be added to the end of the base video content. In an alternative arrangement, the user is able to use the interface to select an insertion point in the base video content at which the user video content is to be inserted. In one implementation, the interface provides a set of predefined insertion points in the base video content from which the user can select the insertion point.

Control passes from step 145 to step 150, which merges the base video content and the user video content to produce a co-created, user endorsed commercial. One implementation appends the user video content to the base video content. Another implementation splices the user video content into the base video content at a selected insertion point. Step 150 optionally includes applying a censoring function to ensure that the user video content does not include prohibited content, such as bad language or nudity. In step 155, the user endorsed commercial is published, such as through an app or through a website. In one arrangement, step 155 is optional and control passes directly through to step 160.

In decision step 160, the user is able to choose whether to share the user endorsed commercial with friends, family, fans, followers, and the like. If the user chooses not to share the user endorsed commercial, No, control passes to step 170 and the method 100 terminates. If the user chooses to share the user endorsed commercial, Yes, control passes from step 160 to step 165, in which the user shares the user endorsed commercial. Sharing of the user endorsed commercial can be effected through email, Short Message Service (SMS) text message, Multimedia Message Service (MMS) text message, hyperlinks, or social media platforms, such as Facebook, Twitter, Instagram, Pinterest, and the like. A recipient of a shared commercial is then able to share the commercial to other friends, family, fans, followers, and the like. The recipient may merely forward the shared commercial or alternatively the recipient is able to record their own user video content to be merged into the shared commercial. This enables the creation of a conversation within the commercial as multiple sections of user recorded content are merged with the original base video content.

In one arrangement, the advertiser associated with the commercial defines a limited number of insertion points, such that user generated content can only be inserted at those insertion points. This acts to limit the number of user contributions in any single “conversation”. In one implementation, when a recipient receives a shared commercial that includes a number of user generated videos corresponding to a predefined number of insertion points, the recipient is able to replace the oldest inserted user video content with new video content. Control passes from step 165 to step 170 and the method 100 terminates. In another arrangement, the user generated content can be added at any point of the shared commercial. In a simple example, user generated content is appended to the end of the shared commercial.

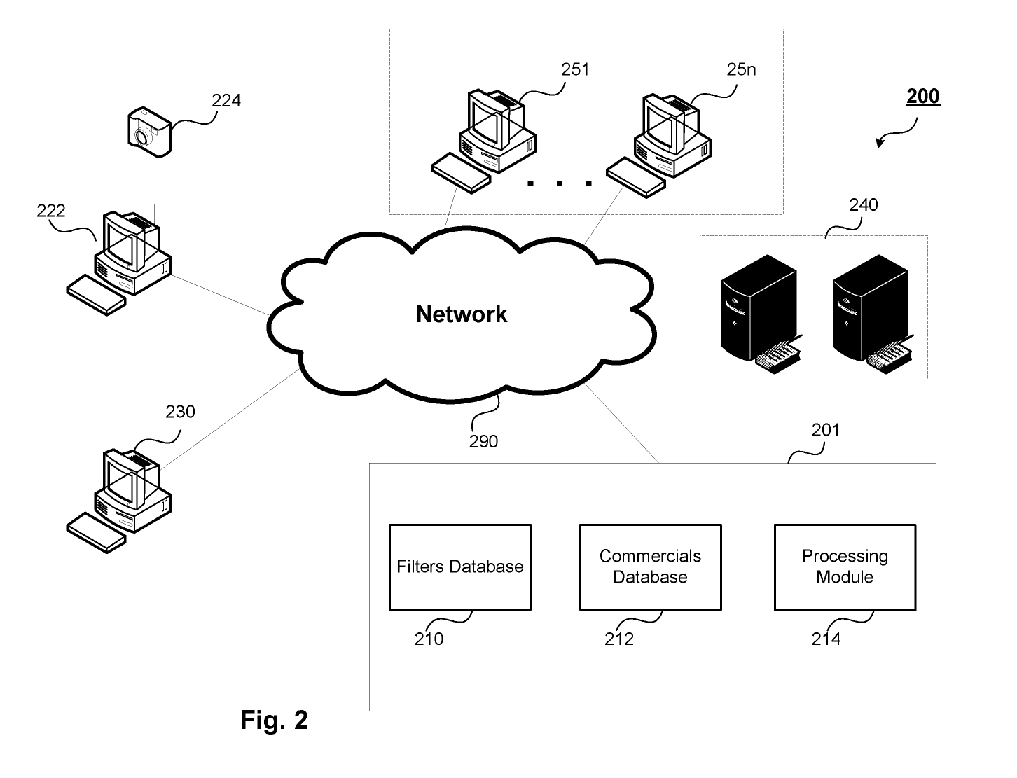

FIG. 2 is a schematic block diagram representation of a system 200 on which a method for producing a video advertisement containing user content can be practised. The system 200 includes a server 201 for implementing a method of producing user endorsed commercials. The server 201 is connected to a communications network 290 and includes a filters database 210, a commercials database 212, and a processing module 214. The communications network 290 may be implemented using one or more wired or wireless transmission links and may include, for example, a dedicated communications link, a local area network (LAN), a wide area network (WAN), the Internet, a telecommunications network, or any combination thereof. A telecommunications network may include, but is not limited to, a telephony network, such as a Public Switch Telephony Network (PSTN), a mobile telephone cellular network, a short message service (SMS) network, a multimedia message service (MMS) network, or any combination thereof.

The filters database 210 stores one or more themes that can be applied to a commercial, wherein each theme is associated with a set of filters. The commercials database 212 stores one or more commercials that have been uploaded to the server 201 or created using software hosted on the processing module 214. Each commercial is stored with a profile, wherein each profile includes a set of filters. The processing module 214 is used to apply filters from the set of filters to raw video content or user video content received in relation to a commercial.

The system 200 also includes a first computing device 222 associated with a video camera 224, wherein the video camera is used to film raw video content relating to a commercial. The raw video content is uploaded using the first computing device 222 to the server 201, via the communications network 290. The server 201 receives the raw video content and the processing module 214 applies, from the filters database 210, a set of filters associated with a theme selected for the commercial and stores the processed base video content as a commercial in the commercials database 212.

In one arrangement, the server 201 pushes a software application (“app”) to the first computing device 222, wherein the app controls communication between the first computing device 222 and the server 201. In such an arrangement, the app includes an interface that enables a user of the first computing device 222 to select a theme to be applied to the raw video content. The interface optionally allows the user to edit other aspects of the video content, such as length, music, lighting, cropping, and the like. In another arrangement, the app applies one or more selected filters to raw video content captured and recorded by the video camera 224, such that the raw video content uploaded to the server 201 has already had a set of filters applied.

The system 200 also includes a second computing device 230 accessed by a viewing user to view a commercial. In one arrangement, the viewing user installs an app from the server 201, or other website, to the second computing device 230. The viewing user uses the app to view content, which may include one or more commercials published by the server 201. When viewing a commercial, the viewing user is able to activate a control associated with the commercial and subsequently record user content relating to that commercial.

In one arrangement, the app controls a camera of the second computing device 230 and applies a set of filters to any new content recorded using that camera, wherein the set of filters corresponds to filters in the profile associated with that commercial. Consequently, new user recorded content has the same look and feel as the content of the original commercial. The viewing user is also able to upload pre-recorded content to the app executing on the second computing device 230 from a local or remote storage device (not shown) and optionally edit the pre-recorded content. Editing the pre-recorded content may include, for example, applying a set of filters, selecting a set of frames to produce a video clip corresponding to a predefined clip length, cropping, and the like.

In another arrangement, the viewing user uses a browser executing on a processor of the second computing device 230 to access content hosted by the commercials database 212 of the server 201. The viewing user is able to activate a control associated with the commercial to record user content relating to that commercial. In one implementation, the browser includes a plugin that applies a set of filters to any new content recorded by the user using a camera of the second computing device 230, wherein the set of filters corresponds to filters in the profile associated with the commercial that the viewing user is watching. The plugin is also able to apply a set of filters to pre-recorded content uploaded by the viewing user.

Content recorded by the viewing user on the second computing device 230 or uploaded by the viewing user to the second computing device 230 is uploaded to the processing module 214 of the server 201 via the communications network 290. The processing module 214 merges the received user video content with the base video content of the commercial to produce a user endorsed commercial. In one arrangement, the processing module 214 appends the received user video content to the end of the base video content or inserts the received user video content at a predefined insertion point. In an alternative arrangement, the viewing user selects an insertion point of the base video content at which the user video content is to be inserted. In one implementation, the insertion point is selected from a set of predefined insertion points.

In one arrangement, the processing module 214 optionally includes a censoring function that monitors the received user content for explicit material, such as swear words, nudity, and the like. The monitoring of swear words and the like may be implemented using a black list of forbidden or prohibited words. Monitoring for nudity may require an analysis of foreground and background objects within a scene. If any forbidden content is detected, the processing module 214 sends a message to the second computing device 230 notifying the viewing user that the submitted content has been blocked.

In one implementation, the censoring function is applied to submitted content that is to be published to an online environment, such as via a hosted website or online portal or pushed out to apps installed on user computing devices, but is not applied to content that is to be shared among friends within a social media platform, for example. In one implementation, the censoring function has one or more settings controlled by an advertiser associated with the base commercial, wherein the settings control the type of content that is to be identified, such as bad language or nudity, and the content to which the censoring function is to be applied, such as publicly posted commercials. In another implementation, an administrator of a hosted website or online portal that publishes commercials is able to control one or more settings associated with the censoring function.

The user endorsed commercial is then available to be published, such as being available on a website or pushed out to one or more installations of an app associated with the server 201. The viewing user is able to share the user endorsed commercial with one or more family, friends, fans, or followers. In one example, the viewing user shares the user endorsed commercial via one or more social media portals 240. In another example, the viewing user shares the user endorsed commercial via an email, SMS text message, MMS text message, or other notification sent to accounts accessed by computing devices 251, . . . , 25n.

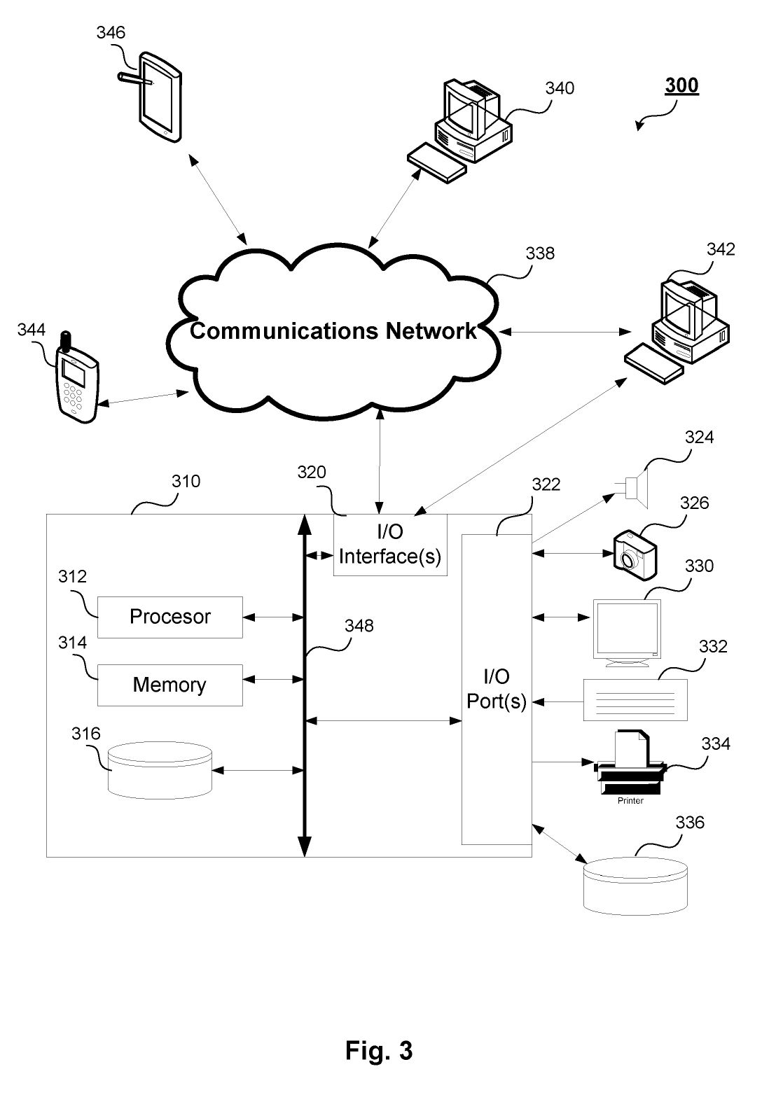

The user endorsed commercial producing system of the present disclosure may be practised using a computing device, such as a general purpose computer or computer server. FIG. 3 is a schematic block diagram of a system 300 that includes a general purpose computer 310. The general purpose computer 310 includes a plurality of components, including: a processor 312, a memory 314, a storage medium 316, input/output (I/O) interfaces 320, and input/output (I/O) ports 322. Components of the general purpose computer 310 generally communicate using one or more buses 348.

The memory 314 may be implemented using Random Access Memory (RAM), Read Only Memory (ROM), or a combination thereof. The storage medium 316 may be implemented as one or more of a hard disk drive, a solid state “flash” drive, an optical disk drive, or other storage means. The storage medium 316 may be utilised to store one or more computer programs, including an operating system, software applications, and data. In one mode of operation, instructions from one or more computer programs stored in the storage medium 316 are loaded into the memory 314 via the bus 348. Instructions loaded into the memory 314 are then made available via the bus 348 or other means for execution by the processor 312 to effect a mode of operation in accordance with the executed instructions.

One or more peripheral devices may be coupled to the general purpose computer 310 via the I/O ports 322. In the example of FIG. 3, the general purpose computer 310 is coupled to each of a speaker 324, a camera 326, a display device 330, an input device 332, a printer 334, and an external storage medium 336. The speaker 324 may be implemented using one or more speakers, such as in a stereo or surround sound system.

The camera 326 may be a webcam, or other still or video digital camera, and may download and upload information to and from the general purpose computer 310 via the I/O ports 322, dependent upon the particular implementation. For example, images recorded by the camera 326 may be uploaded to the storage medium 316 of the general purpose computer 310. Similarly, images stored on the storage medium 316 may be downloaded to a memory or storage medium of the camera 326. The camera 326 may include a lens system, a sensor unit, and a recording medium. In one arrangement, a software application executing on the processor 312 controls video content captured using the camera 326 by applying a set of filters. In one arrangement, a live preview mode enables a user of the computer 310 to view on the display 330 content being recorded by the camera 326. In such an arrangement, the live preview mode is optionally controlled to show the content with the appropriate set of filters applied thereto.

The display device 330 may be a computer monitor, such as a cathode ray tube screen, plasma screen, or liquid crystal display (LCD) screen. The display 330 may receive information from the computer 310 in a conventional manner, wherein the information is presented on the display device 330 for viewing by a user. The display device 330 may optionally be implemented using a touch screen to enable a user to provide input to the general purpose computer 310. The touch screen may be, for example, a capacitive touch screen, a resistive touchscreen, a surface acoustic wave touchscreen, or the like.

The input device 332 may be a keyboard, a mouse, a stylus, drawing tablet, or any combination thereof, for receiving input from a user. The external storage medium 336 may include an external hard disk drive (HDD), an optical drive, a floppy disk drive, a flash drive, or any combination thereof and may be implemented as a single instance or multiple instances of any one or more of those devices. For example, the external storage medium 336 may be implemented as an array of hard disk drives.

The I/O interfaces 320 facilitate the exchange of information between the general purpose computing device 310 and other computing devices. The I/O interfaces may be implemented using an internal or external modem, an Ethernet connection, or the like, to enable coupling to a transmission medium. In the example of FIG. 3, the I/O interfaces 322 are coupled to a communications network 338 and directly to a computing device 342. The computing device 342 is shown as a personal computer, but may be equally be practised using a smartphone, laptop, or a tablet device. Direct communication between the general purpose computer 310 and the computing device 342 may be effected using a wireless or wired transmission link.

The communications network 338 may be implemented using one or more wired or wireless transmission links and may include, for example, a dedicated communications link, a local area network (LAN), a wide area network (WAN), the Internet, a telecommunications network, or any combination thereof. A telecommunications network may include, but is not limited to, a telephony network, such as a Public Switch Telephony Network (PSTN), a mobile telephone cellular network, a short message service (SMS) network, or any combination thereof. The general purpose computer 310 is able to communicate via the communications network 338 to other computing devices connected to the communications network 338, such as the mobile telephone handset 344, the touchscreen smartphone 346, the personal computer 340, and the computing device 342.

One or more instances of the general purpose computer 310 may be utilised to implement a server 201 acting as a centrally located server to effect a commercial processing system in accordance with the present disclosure. In such an embodiment, the memory 314 and storage 316 are utilised to store data relating to filters, stored commercials, and associated profiles. Software for implementing the commercial producing system is stored in one or both of the memory 314 and storage 316 for execution on the processor 312. The software includes computer program code for effecting method steps in accordance with the method of producing user endorsed commercials described herein.

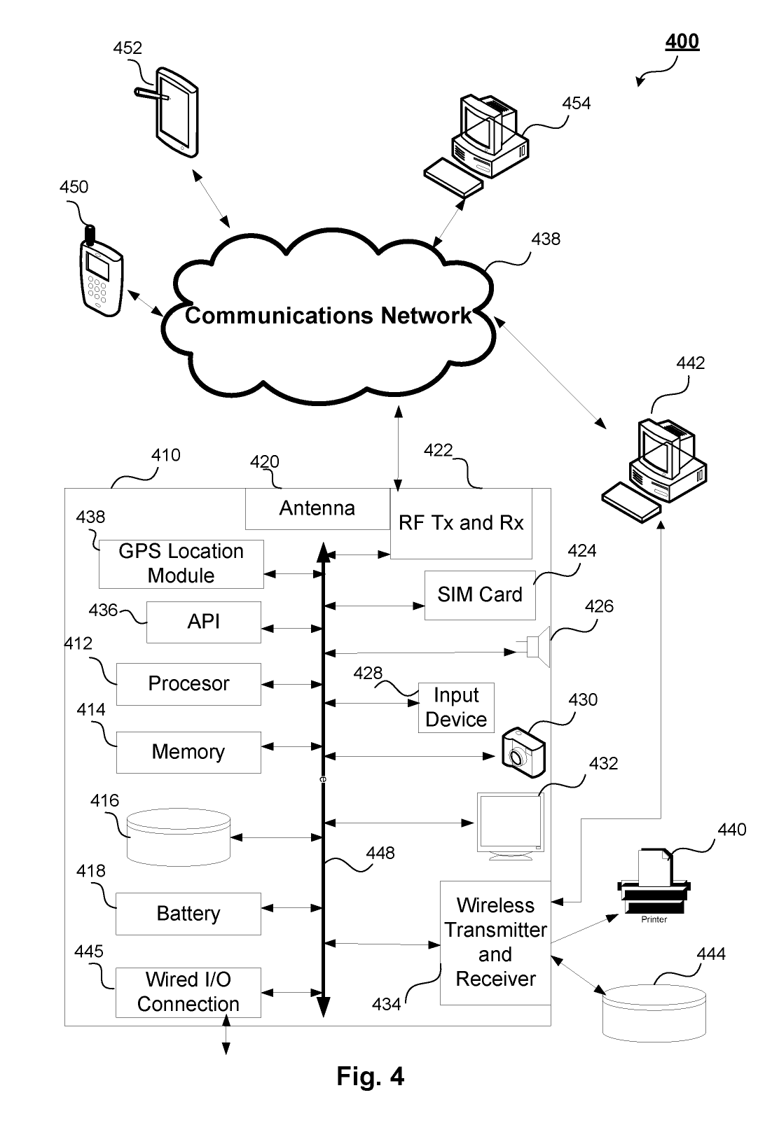

FIG. 4 is a schematic block diagram of a system 400 on which one or more aspects of a method and system for producing user endorsed commercials may be practised. The system 400 includes a portable computing device in the form of a smartphone 410, which may be used by a registered user of the commercial producing system 201 of FIG. 2, such as to perform the role of the second computing device 230. The smartphone 410 includes a plurality of components, including: a processor 412, a memory 414, a storage medium 416, a battery 418, an antenna 420, a radio frequency (RF) transmitter and receiver 422, a subscriber identity module (SIM) card 424, a speaker 426, an input device 428, a camera 430, a display 432, and a wireless transmitter and receiver 434. Components of the smartphone 410 generally communicate using one or more bus connections 448 or other connections therebetween. The smartphone 410 also includes a wired connection 445 for coupling to a power outlet to recharge the battery 418 or for connection to a computing device, such as the general purpose computer 310 of FIG. 3. The wired connection 445 may include one or more connectors and may be adapted to enable uploading and downloading of content from and to the memory 414 and SIM card 424.

The smartphone 410 may include many other functional components, such as an audio digital-to-analogue and analogue-to-digital converter and an amplifier, but those components are omitted for the purpose of clarity. However, such components would be readily known and understood by a person skilled in the relevant art.

The memory 414 may include Random Access Memory (RAM), Read Only Memory (ROM), or a combination thereof. The storage medium 416 may be implemented as one or more of a solid state “flash” drive, a removable storage medium, such as a Secure Digital (SD) or microSD card, or other storage means. The storage medium 416 may be utilised to store one or more computer programs, including an operating system, software applications, and data. In one mode of operation, instructions from one or more computer programs stored in the storage medium 416 are loaded into the memory 414 via the bus 448. Instructions loaded into the memory 414 are then made available via the bus 448 or other means for execution by the processor 412 to effect a mode of operation in accordance with the executed instructions.

The smartphone 410 also includes an application programming interface (API) module 436, which enables programmers to write software applications to execute on the processor 412. Such applications include a plurality of instructions that may be pre-installed in the memory 414 or downloaded to the memory 414 from an external source, via the RF transmitter and receiver 422 operating in association with the antenna 420 or via the wired connection 445.

The smartphone 410 further includes a Global Positioning System (GPS) location module 438. The GPS location module 438 is used to determine a geographical position of the smartphone 410, based on GPS satellites, cellular telephone tower triangulation, or a combination thereof. The determined geographical position may then be made available to one or more programs or applications running on the processor 412.

The wireless transmitter and receiver 434 may be utilised to communicate wirelessly with external peripheral devices via Bluetooth, infrared, or other wireless protocol. In the example of FIG. 4, the smartphone 410 is coupled to each of a printer 440, an external storage medium 444, and a computing device 442. The computing device 442 may be implemented, for example, using the general purpose computer 310 of FIG. 3.

The camera 426 may include one or more still or video digital cameras adapted to capture and record to the memory 414 or the SIM card 424 still images or video images, or a combination thereof. The camera 426 may include a lens system, a sensor unit, and a recording medium. A user of the smartphone 410 may upload the recorded images to another computer device or peripheral device using the wireless transmitter and receiver 434, the RF transmitter and receiver 422, or the wired connection 445.

In one example, the display device 432 is implemented using a liquid crystal display (LCD) screen. The display 432 is used to display content to a user of the smartphone 410. The display 432 may optionally be implemented using a touch screen, such as a capacitive touch screen or resistive touchscreen, to enable a user to provide input to the smartphone 410.

The input device 428 may be a keyboard, a stylus, or microphone, for example, for receiving input from a user. In the case in which the input device 428 is a keyboard, the keyboard may be implemented as an arrangement of physical keys located on the smartphone 610. Alternatively, the keyboard may be a virtual keyboard displayed on the display device 432.

The SIM card 424 is utilised to store an International Mobile Subscriber Identity (IMSI) and a related key used to identify and authenticate the user on a cellular network to which the user has subscribed. The SIM card 424 is generally a removable card that can be used interchangeably on different smartphone or cellular telephone devices. The SIM card 424 can be used to store contacts associated with the user, including names and telephone numbers. The SIM card 424 can also provide storage for pictures and videos. Alternatively, contacts can be stored on the memory 414.

The RF transmitter and receiver 422, in association with the antenna 420, enable the exchange of information between the smartphone 410 and other computing devices via a communications network 438. In the example of FIG. 4, RF transmitter and receiver 422 enable the smartphone 410 to communicate via the communications network 438 with a cellular telephone handset 450, a smartphone or tablet device 452, a computing device 454 and the computing device 442. The computing devices 454 and 442 are shown as personal computers, but each may be equally be practised using a smartphone, laptop, or a tablet device.

The communications network 438 may be implemented using one or more wired or wireless transmission links and may include, for example, a cellular telephony network, a dedicated communications link, a local area network (LAN), a wide area network (WAN), the Internet, a telecommunications network, or any combination thereof. A telecommunications network may include, but is not limited to, a telephony network, such as a Public Switch Telephony Network (PSTN), a cellular (mobile) telephone cellular network, a short message service (SMS) network, or any combination thereof.

In one arrangement, an operator of the server 201 charges a provider of raw video content relating to a commercial for services associated with processing, storing, and publishing the base video commercial. Different charges may be applied dependent on the nature and extent of the filters and the manner in which the base video commercial is published. In one example, the server 201 stores a database of users and charges relate to a number of users within the database to which the base video content is published.

In one arrangement, the server 201 stores data relating to the number of viewing users that view a commercial via an app or browser, the times at which the commercial is viewed, and the extent to which each viewing user shares a user endorsed commercial. Such data may be used to determine the ultimate reach of an advertising campaign relating to one or more commercials.

In a further arrangement, the server 201 offers the ability to produce low cost commercials through the provision of one or more predefined themes that can be applied to raw video content and the provision of an interface for a viewing user to create, modify, and merge user created video content.

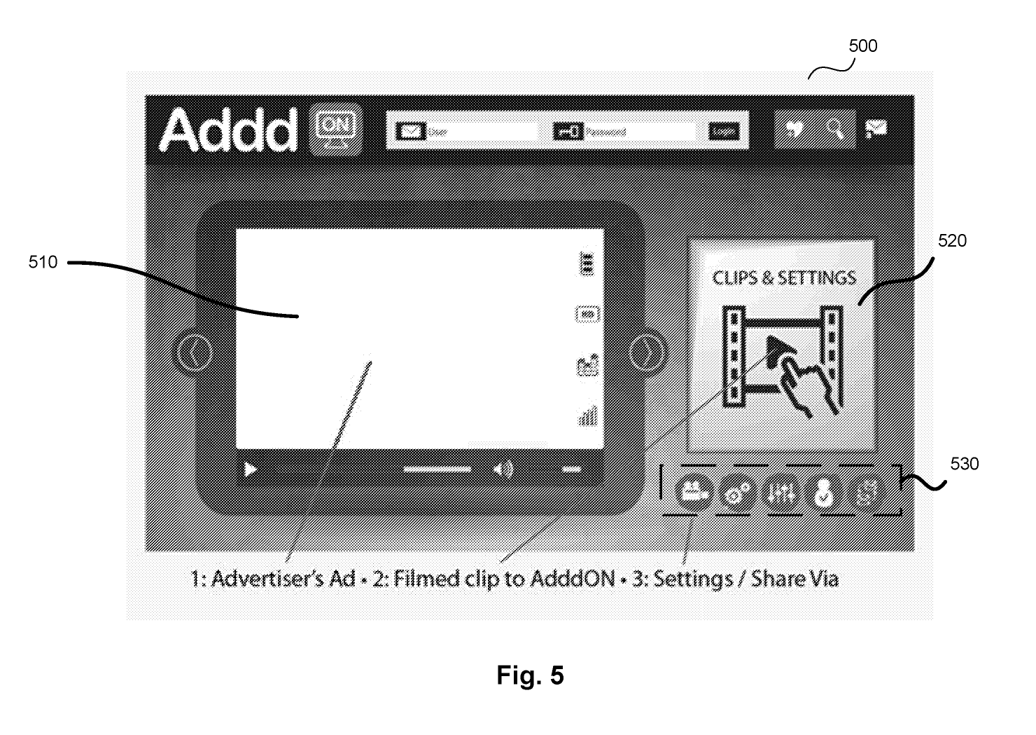

FIG. 5 is an interface 500 that can be used in relation to step 145 of FIG. 1 to enable a viewing user to view commercials, record user content, and edit user content to be merged with base video content of a commercial in order to form a user endorsed commercial. The interface 500 includes a first viewing pane 510 for viewing commercials and a second viewing pane 520 for viewing user recorded or user provided content. The interface 500 also includes a set of controls 530 to record user video content, upload pre-recorded video content, upload pre-recorded audio content, edit recorded user video content, submit the user recorded content for merging, and share a user endorsed commercial with one or more family members, friends, fans, or followers.

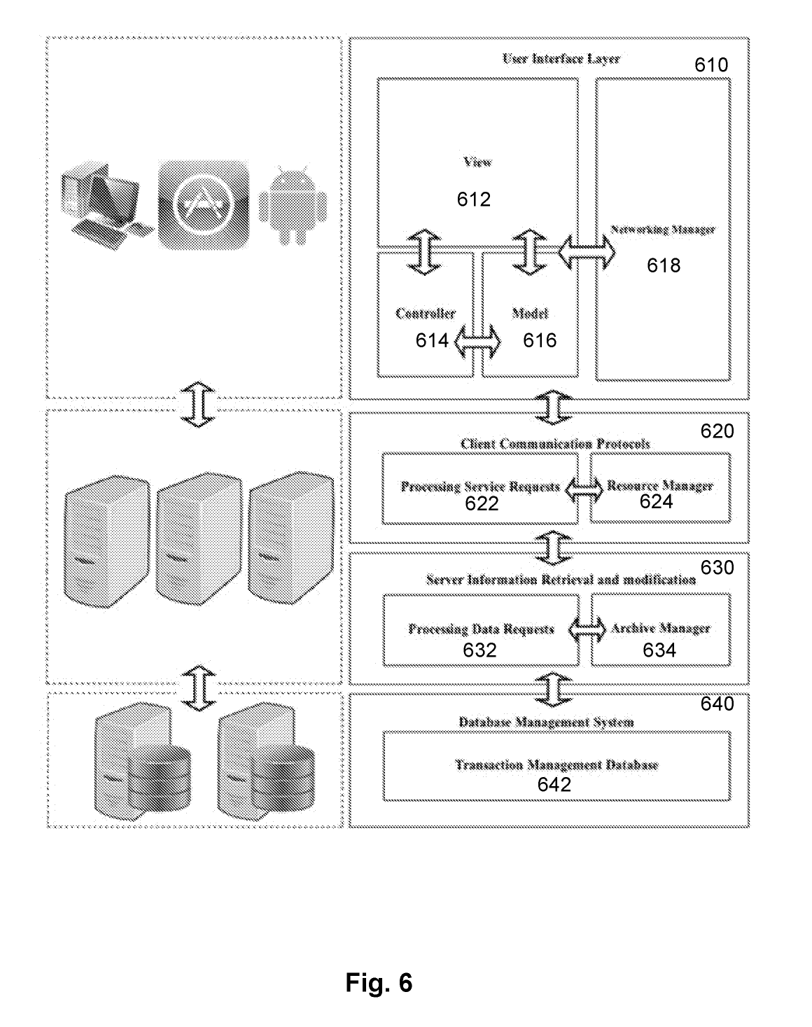

FIG. 6 is a schematic block diagram representation of a general system architecture for implementing a system for producing user endorsed commercials, wherein each user endorsed commercial includes video content provided by a viewing user. In this example, the system is implemented using a multi layered architecture approach, where each layer corresponds to a physical system. The layers are partitioned by services corresponding to a User Interface (UI) 610, client system communications protocols 620, server Information retrieval and modification 630, along with the database management system 640.

The user interface layer 610 runs locally on a computing device accessed by a viewing user, such as the second computing device 230 of FIG. 2, using a web browser or through a smartphone application. The user interface layer 610 is responsible for presenting information to be viewed on display devices of the computing devices 230, 340, 342, 344, 346 of FIGS. 2 and 3 and for receiving input from those computing devices. In one arrangement, the user interface layer 610 runs locally on one or more of the computing devices 230, 340, 342, 344, 346. In an alternative arrangement, the user interface layer 610 executes on the server 201, which pushes content to the computing devices 230, 340, 342, 344, 346 to be viewed in a browser window. In one arrangement, this user interface layer 610 is implemented utilising the model, view, controller design pattern, wherein the user interface layer 610 includes a view module 612, a controller module 614, a model module 616, and a networking manager 618.

The view module 612 is responsible for displaying data received from the model module 616 or upon receiving an update request from the controller module 614. The view module 612 invokes function calls on the associated controller module 614 to respond to user requests from the user interface 610. These events are a product of the application environment.

The model module 616 maintains data being processed by the web application and triggers events on updates and changes to the state of each page. The controller module 614 is responsible for listening for events raised by the views and updating or modifying the models accordingly and vice versa.

The networking manager 618 is implemented using a router or other network device to parse Uniform Resource Locators (URLs) of the application, so that an internet connection can be established.

The client communication protocol layer 620 runs on a selected hosting platform. The client communication protocol layer 620 is the interface between the client machine and the back end application services. The client communication protocol layer 620 includes a Processing Service Requests subsystem 622, which is responsible for processing service requests, and a Resource Manager 624. Typically, the client communication protocol layer 620 is responsible for receiving and handling HTTP requests from the web clients via the User Interface layer 610, sanitising input and performing authentication checks, along with setting up requests to the Information retrieval and modification layers 630.

The information retrieval and modification layer 630 is responsible for communicating with the database management system 640. This database can also be hosted using a web service. The information retrieval and modification layer 630 processes the data requests using a Processing Data Requests module 632 and an Archive Manager 634 and sets up specific database access queries to pass to the database layer 640 for retrieving and modifying any data. This may be implemented, for example, using a development language such as PHP, JSP, APS.NET, PERL, Ruby on Rails, and the like.

The client communication protocol layer 620 and information retrieval and modification layer 630 function together to control communication between the server 201 and one or more computing devices 230, 340, 342, 344, 346 and retrieve information from the filters database 210 and commercials database 212 as required.

The database management system 640 includes a Transaction Management database 642 implemented using a database server. Typical database types which are used for web applications include postgresql, SQLite, MySQL, and the like. The transaction management database is the main source of storage for the application and contains the relational structures and tables which store the data. The database management system 640 may be used to implement each of the filters database 210 and commercials database 212 of FIG. 2.

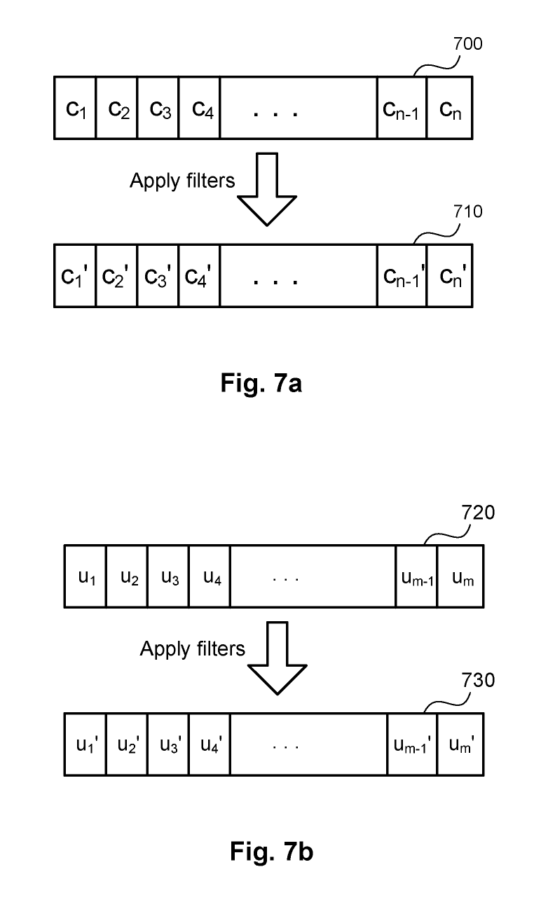

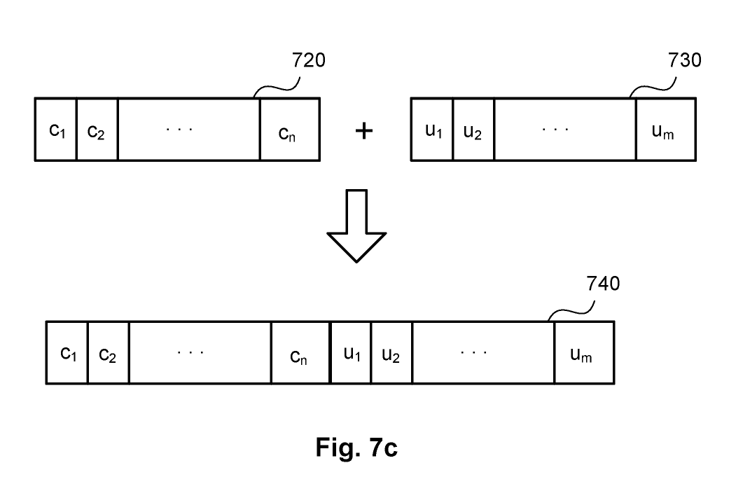

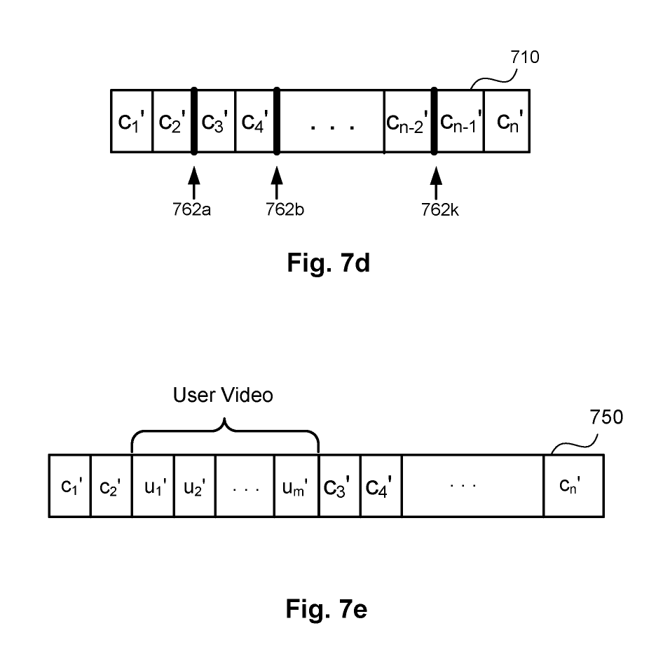

FIG. 7a is a schematic block diagram representation of a base video commercial comprised of n frames. In this example, an advertiser records base video content 700 comprising n frames c₁ . . . cₙ. The processing module 214 of the system 201 applies a set of filters to obtain base video commercial 710 comprising n frames c₁′ . . . cₙ′. The base video commercial 710 is stored with an associated profile that indicates that set of filters that were applied to the original base video content.

FIG. 7b is a schematic block diagram representation of a user video commercial comprised of m frames. In this example, a viewing user records or uploads base video content 720 comprising m frames u₁ . . . uₘ. The processing module 214 of the system 201 applies a set of filters corresponding to the set of filters in the profile associated with the base video commercial to obtain user video commercial 730 comprising m frames u₁′ . . . uₘ′. The user video commercial 730 is then available to be inserted into the base video commercial.

FIG. 7c is a schematic block diagram representation illustrating the joining of the base video commercial 720 with the user video commercial 730. In this example, the user video commercial 730 is appended to the last frame cₙ of the base video commercial 720 to produce the user endorsed video commercial 740.

As described above, different implementations allow the viewing user to select an insertion point within the base commercial video. In one implementation, an app embodying the method of the present disclosure provides a user interface to a display of a computing device accessed by the viewing user, wherein the user interface provides a set of one or more predefined insertion points.

FIG. 7d is a schematic block diagram representation showing one arrangement in which the base video commercial 710 has a set of predefined insertion points 762a . . . 762k, wherein in this example each insertion point is after every 2 frames. FIG. 7e is a schematic block diagram representation showing a user endorsed video commercial based on the base video commercial 710 and the user video commercial 730, wherein the viewing user has selected the insertion point 762a as the point at which to insert the user video commercial 730 into the base video commercial 710. It will be appreciated by those skilled in the relevant art that any number of predefined insertion points may be used, at many locations within the base video commercial, without departing from the spirit and scope of the present disclosure.

### INDUSTRIAL APPLICABILITY

The arrangements described are applicable to the retail industries and particularly for the advertising industry.

The foregoing describes only some embodiments of the present invention, and modifications and/or changes can be made thereto without departing from the scope and spirit of the invention, the embodiments being illustrative and not restrictive.

In the context of this specification, the word “comprising” and its associated grammatical constructions mean “including principally but not necessarily solely” or “having” or “including”, and not “consisting only of”. Variations of the word “comprising”, such as “comprise” and “comprises” have correspondingly varied meanings.

As used throughout this specification, unless otherwise specified, the use of ordinal adjectives “first”, “second”, “third”, “fourth”, etc., to describe common or related objects, indicates that reference is being made to different instances of those common or related objects, and is not intended to imply that the objects so described must be provided or positioned in a given order or sequence, either temporally, spatially, in ranking, or in any other manner.

Although the invention has been described with reference to specific examples, it will be appreciated by those skilled in the art that the invention may be embodied in many other forms.

1. A method for producing a video advertisement, comprising the steps of:
receiving raw video content comprising a first image sequence;
applying a set of filters to said raw video content to produce a base video commercial in a first format;
displaying said base video commercial to a user;
receiving user video content from said user, said user video content comprising a second image sequence
applying said set of filters to said user video content to generate processed user video content; and
merging said second image sequence of said processed user video content with said first image sequence of said base video commercial to produce said video advertisement.

2. The method according to claim 1, wherein said set of filters corresponds to a predefined theme.

3. The method according to claim 1, wherein said set of filters includes at least one of an aperture setting, tone, colour, and music.

4. The method according to claim 1, wherein said user video content is merged with said base video commercial at a selected point.

5. The method according to claim 4, wherein said selected point is one of a set of predefined insertion points associated with said base video commercial.

6. The method according to claim 4, wherein said selected point is after a last frame of said base video commercial.

7. (canceled)

8. The method according to claim 1, wherein said first format includes at least one of a compression format and an aspect ratio.

9. The method according to claim 1, comprising the further step of:
recording said user video content using a camera of a computing device accessed by said user, wherein said camera is controlled via a software application executing on said computing device, said application applying said set of filters to said content as the content is recorded.

10. The method according to claim 1, comprising the further step of:
recording said user video content using a camera of a computing device accessed by said user, wherein said camera is controlled via a software application executing in a browser window executing on said computing device, said application applying said set of filters to said content as the content is recorded.

11. A video advertisement production system, comprising:
a server including:
a memory for storing data, a computer program, and a plurality of filters;
a processor coupled to said memory for executing said computer program stored in said memory;
a video production application forming part of said computer program, said video production application including instructions for performing the method steps of:
receiving raw video content comprising a first image sequence;
applying a set of filters selected from said plurality of filters to said raw video content to produce a base video commercial in a first format;
publishing said base video commercial;
receiving user video content, said user video content comprising a second image sequence;
applying said plurality of filters to said user video content to generate processed user video content; and
merging said second image sequence of said processed user video content with said first image sequence of said base video commercial to produce a user endorsed video advertisement.

12. The video advertisement production system according to claim 11, wherein said memory stores a set of themes, each theme being associated with a set of filters selected from said plurality of filters.

13. The video advertisement production system according to claim 11, wherein said first format includes at least one of a compression format and an aspect ratio.

14. The video advertisement production system according to claim 11, further including:
a user computing device including:
a second memory for storing a second computer program; and
a second processor coupled to said second memory for executing said second computer program stored in said second memory;
a lens system;
a user video application forming part of said second computer program, said video application including instructions for performing the method steps of:
displaying a base video commercial pushed from said video production application;
activating a control to use said lens system to record user video content;
applying to said user video content said set of filters in said profile associated with said base video commercial; and
uploading said base video commercial to said video production application executing on said server.

15. The video advertisement production system according to claim 11, wherein publishing said base video commercial includes pushing said based video commercial to said user video application executing on said user computing device.

16. The video advertisement production system according to claim 11, wherein publishing said base video commercial includes hosting said commercial on a website.

17. A method for producing a video advertisement, comprising the steps of:
receiving a base video commercial comprising a first image sequence, said base video commercial being associated with a profile;
displaying said base video commercial to a user;
receiving user video content from said user, said user video content comprising a second image sequence;
processing said user video content based on said profile to generate processed user video content; and
merging said second image sequence of said processed user video content with said first image sequence of said base video commercial to produce said video advertisement.
